(19) United States
(12) Patent Application Publication
(10) Pub. No.: US 2021/0345302 A1
(43) Pub. Date: Nov. 4, 2021

(54) TELECOMMUNICATIONS APPARATUS AND METHODS

(71) Applicant: Sony Corporation, Tokyo (JP)

(72) Inventors: Shin Horng WONG, Basingstoke (GB); Martin Warwick BEALE, Basingstoke (GB)

(73) Assignee: Sony Corporation, Tokyo (JP)

(21) Appl. No.: 17/280,916

(22) PCT Filed: Oct. 29, 2019
(86) PCT No.: PCT/EP2019/079514

§ 371 Date: Mar. 29, 2021

(30) Foreign Application Priority Data
Nov. 1, 2018 (EP) 18204002.2

(51) Int. Cl. H04W 72/04

(52) U.S. Cl. CPC H04W 72/04

(57) ABSTRACT

A method of transmitting data by a terminal device in a wireless telecommunications system, wherein the method comprises the terminal device: determining there is data available for transmission by the terminal device; selecting a proposed radio resource allocation to use for transmitting the data; transmitting request signalling comprising a request to use the proposed radio resource allocation for transmitting the data; receiving response signalling comprising an indication of whether or not the request to use the proposed radio resource allocation for transmitting the data is allowed; and transmitting the data using the proposed radio resource allocation if the response signalling indicates the request to use the proposed radio resource allocation for transmitting the data is allowed.

### BACKGROUND

### Field

The present disclosure relates to wireless telecommunications apparatus and methods.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to efficiently support communications with a wider range of devices associated with a wider range of data traffic profiles and types than current systems are optimised to support. For example it is expected future wireless communications networks will be expected to efficiently support communications with devices including reduced complexity devices, machine type communication devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Yet other types of device, for example used for autonomous vehicle communications, may be characterised by data that should be transmitted through the network with low latency. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario.

In view of this there is expected to be a desire for future wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles.

Example use cases currently considered to be of interest for next generation wireless communication systems include so-called Enhanced Mobile Broadband (eMBB) and Ultra Reliable and Low Latency Communications (URLLC). See, for example, the 3GPP documents RP-160671, “New SID Proposal: Study on New Radio Access Technology,” NTT DOCOMO, RAN#71 [1]; RP-172834, “Work Item on New Radio (NR) Access Technology,” NTT DOCOMO, RAN#78 [2]; and RP-182089, “New SID on Physical Layer Enhancements for NR Ultra-Reliable and Low Latency Communication (URLLC),” Huawei, HiSilicon, Nokia, Nokia Shanghai Bell, RAN#81 [3].

eMBB services may be typically characterised as high capacity services, for example, supporting up to 20G b/s. For efficient transmission of large amounts of data at high throughput, eMBB services may be expected to use slot-based transmissions with relatively long scheduling time so as to help reduce resource allocation signalling overhead, where scheduling time refers to the time available for data transmission between resource allocations. In other words, eMBB services are expected to rely on relatively infrequent allocation messages that allocate radio resources for higher layer data for a relatively long period of time between allocation messages (i.e. such that radio resources are allocated in relatively large blocks).

URLLC services, on the other hand, are low latency services, for example aiming to transmit data through the radio network with a target packet transit time (i.e. time from ingress of a layer 2 packet to its egress from the network) of 1 ms (i.e. so that each piece of URLLC data needs to be scheduled and transmitted across the physical layer in a time that is shorter than 1 ms). URLLC data transmissions are also expected to comprise relatively small amounts of data and to have a correspondingly short scheduling time, i.e. with control signalling and data transmitter with a frame duration that is less than that of eMBB (a typical eMBB frame duration may be expected to be 1 ms, which corresponds to a single slot for 3GPP 5G 15 kHz numerology). A further requirement for URLLC is high reliability with proposals for URLLC packets to be received with a 99.999% reliability within the 1 ms target packet transit time, and recent proposals for this to be increased to 99.9999% with a latency between 0.5 ms and 1 ms.

The inventors have recognized the desire to support transmissions with low latency, such as URLLC data, in wireless telecommunications systems gives rise to new challenges that need to be addressed to help optimise the operation of wireless telecommunications systems.

### SUMMARY

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3a schematically represents a radio resource grid for an example radio frame structure for an eMBB data service;

FIG. 3b schematically represents a radio resource grid for an example radio frame structure for a URLLC data service;

FIG. 4 is a ladder diagram schematically representing signalling message exchange between a terminal device and a radio network access node for uplink transmissions in a wireless telecommunications system.

FIG. 5 schematically represents some aspects of a wireless telecommunication system in accordance with certain embodiments of the present disclosure;

FIG. 6 is a ladder diagram schematically representing signalling message exchange between a terminal device and a radio network access node for uplink transmissions in a wireless telecommunications system in accordance with certain embodiments of the present disclosure;

FIG. 7 is a flow chart schematically representing some operating aspects of a terminal device in accordance with certain embodiments of the disclosure; and

FIG. 8 is a flow chart schematically representing some operating aspects of network infrastructure equipment in accordance with certain embodiments of the disclosure.

### DESCRIPTION OF EXAMPLE EMBODIMENTS

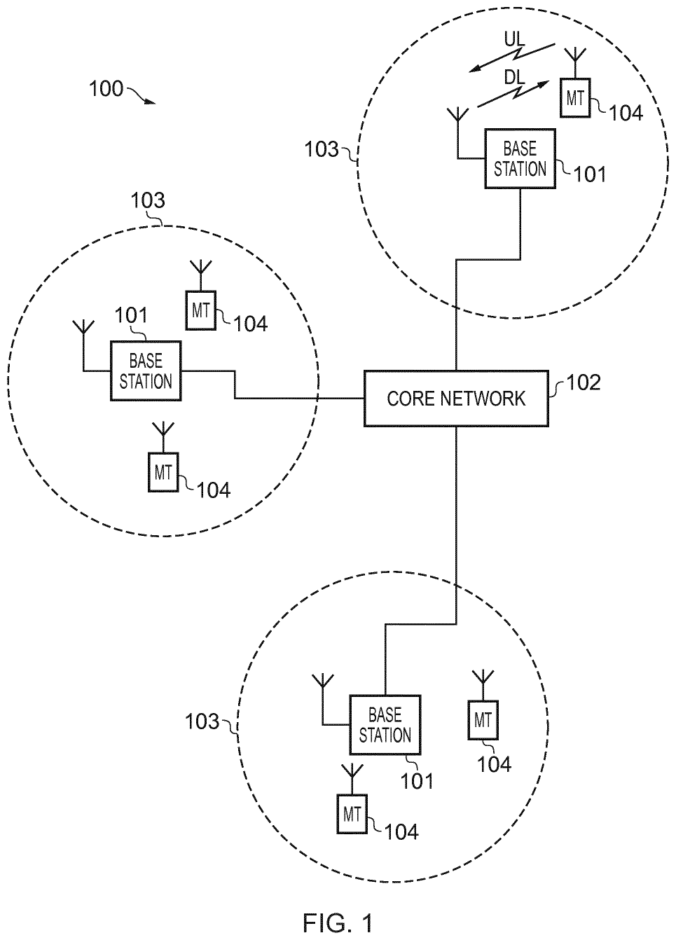

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of

FIG. 1 and certain aspects of their respective modes of operation are well-known and defined in the relevant standards administered by the 3GPP (RTM) body and associated proposals, and also described in many books on the subject, for example, Holma H. and Toskala A [4]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network 102. Each base station provides a coverage area 103 within which data can be communicated to and from terminal devices 104. Data is transmitted from base stations 101 to terminal devices 104 within their respective coverage areas 103 via a radio downlink. The coverage area may be referred to as a cell. Data is transmitted from terminal devices 104 to the base stations 101 via a radio uplink. The core network 102 routes data to and from the terminal devices 104 via the respective base stations 101 and provides functions such as authentication, mobility management, charging and so on. Terminal devices may also be referred to as mobile stations, user equipment (UE), user terminal, mobile radio, communications device, and so forth. Base stations, which are an example of network infrastructure equipment/network access node, may also be referred to as transceiver stations/nodeBs/e-nodeBs, g-nodeBs and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

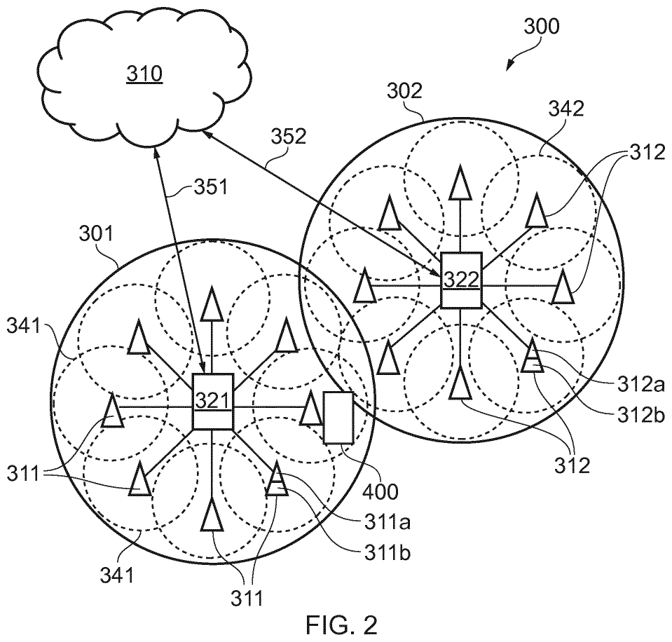

FIG. 2 is a schematic diagram illustrating a network architecture for a new RAT wireless mobile telecommunications network/system 300 based on previously proposed approaches which may also be adapted to provide functionality in accordance with embodiments of the disclosure described herein. The new RAT network 300 represented in FIG. 2 comprises a first communication cell 301 and a second communication cell 302. Each communication cell 301, 302, comprises a controlling node (centralised unit) 321, 322 in communication with a core network component 310 over a respective wired or wireless link 351, 352. The respective controlling nodes 321, 322 are also each in communication with a plurality of distributed units (radio access nodes/remote transmission and reception points (TRPs)) 311, 312 in their respective cells. Again, these communications may be over respective wired or wireless links. The distributed units 311, 312 are responsible for providing the radio access interface for terminal devices connected to the network. Each distributed unit 311, 312 has a coverage area (radio access footprint) 341, 342 which together define the coverage of the respective communication cells 301, 302. Each distributed unit 311, 312 includes transceiver circuitry 311a, 312a for transmission and reception of wireless signals and processor circuitry 311b, 312b configured to control the respective distributed units 311, 312.

In terms of broad top-level functionality, the core network component 310 of the telecommunications system represented in FIG. 2 may be broadly considered to correspond with the core network 102 represented in FIG. 1, and the respective controlling nodes 321, 322 and their associated distributed units/TRPs 311, 312 may be broadly considered to provide functionality corresponding to base stations of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the terminal devices may lie with the controlling node/centralised unit and/or the distributed units/TRPs.

A terminal device 400 is represented in FIG. 2 within the coverage area of the first communication cell 301. This terminal device 400 may thus exchange signalling with the first controlling node 321 in the first communication cell via one of the distributed units 311 associated with the first communication cell 301. In some cases communications for a given terminal device are routed through only one of the distributed units, but it will be appreciated in some other implementations communications associated with a given terminal device may be routed through more than one distributed unit, for example in a soft handover scenario and other scenarios. The particular distributed unit(s) through which a terminal device is currently connected through to the associated controlling node may be referred to as active distributed units for the terminal device. Thus the active subset of distributed units for a terminal device may comprise one or more than one distributed unit (TRP). The controlling node 321 is responsible for determining which of the distributed units 311 spanning the first communication cell 301 is responsible for radio communications with the terminal device 400 at any given time (i.e. which of the distributed units are currently active distributed units for the terminal device). Typically this will be based on measurements of radio channel conditions between the terminal device 400 and respective ones of the distributed units 311. In this regard, it will be appreciated the subset of the distributed units in a cell which are currently active for a terminal device will depend, at least in part, on the location of the terminal device within the cell (since this contributes significantly to the radio channel conditions that exist between the terminal device and respective ones of the distributed units).

In at least some implementations the involvement of the distributed units in routing communications from the terminal device to a controlling node (controlling unit) is transparent to the terminal device 400. That is to say, in some cases the terminal device may not be aware of which distributed unit is responsible for routing communications between the terminal device 400 and the controlling node 321 of the communication cell 301 in which the terminal device is currently operating. In such cases, as far as the terminal device is concerned, it simply transmits uplink data to the controlling node 321 and receives downlink data from the controlling node 321 and the terminal device has no awareness of the involvement of the distributed units 311.

However, in other embodiments, a terminal device may be aware of which distributed unit(s) are involved in its communications. Switching and scheduling of the one or more distributed units may be done at the network controlling node based on measurements by the distributed units of the terminal device uplink signal or measurements taken by the terminal device and reported to the controlling node via one or more distributed units

In the example of FIG. 2, two communication cells 301, 302 and one terminal device 400 are shown for simplicity, but it will of course be appreciated that in practice the system may comprise a larger number of communication cells (each supported by a respective controlling node and plurality of distributed units) serving a larger number of terminal devices.

It will further be appreciated that FIG. 2 represents merely one example of a proposed architecture for a new RAT telecommunications system in which approaches in accordance with the principles described herein may be adopted, and the functionality disclosed herein may also be applied in respect of wireless telecommunications systems having different architectures.

Thus certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a terminal device, wherein the specific nature of the network infrastructure equipment/access node and the terminal device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment may comprise a control unit/controlling node 321, 322 and/or a TRP 311, 312 of the kind shown in FIG. 2 which is adapted to provide functionality in accordance with the principles described herein.

As discussed above, mobile communications networks such the network 100 shown in FIG. 1 and the network 300 shown in FIG. 2 may support services with different characteristics, such as services for which high data throughput with low signalling overhead is a primary concern (e.g. eMBB), and services for which low latency is a primary concern (e.g. URLLC).

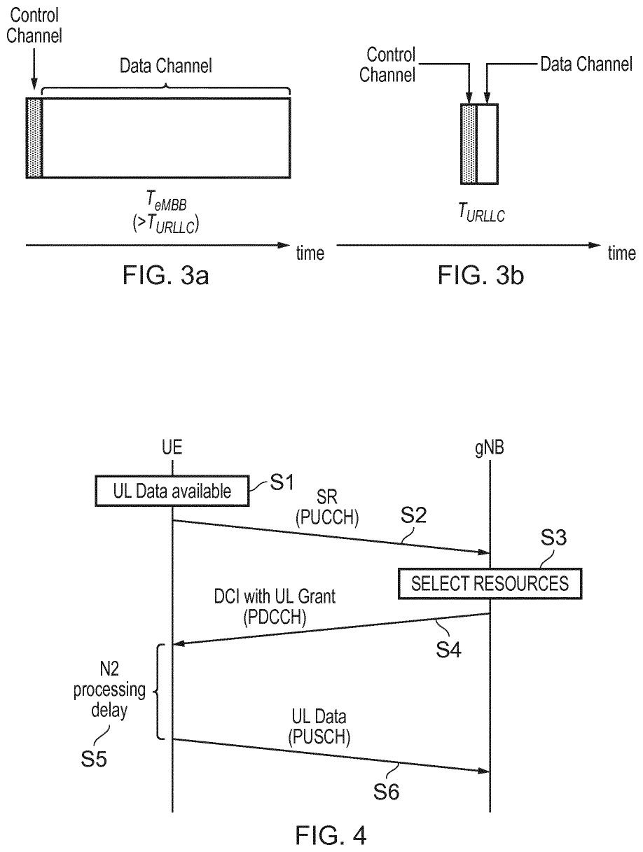

Examples of suitable downlink subframe structures for eMBB data and URLLC data are schematically illustrated in FIGS. 3a and 3b respectively. These figures each schematically represent an array/grid of radio resources arranged in time (horizontal axis) and frequency (vertical axis) that may be used to support the respective services. As is generally conventional for wireless telecommunications systems, each subframe structure in this example comprises a control channel region and a data channel region. The control channel region is used for communicating physical layer control information signalling, for example resource allocation signalling within Downlink Control Information (e.g. corresponding to DCI carried on PDCCH in an LTE context), and the data channel region is used for communicating higher layer data, e.g. data from a layer above the physical layer (e.g. corresponding to PDSCH in an LTE context used to communicate application layer data (which may be referred to as user plane data) and radio resource control signalling).

As can be seen from FIGS. 3a and 3b, the control channel regions at the beginning of each subframe span a broadly comparable period of time, but the eMBB subframe (FIG. 3a) has a data channel region that is longer than the data channel region of the URLLC subframe. Thus the duration T_{eMBB} of the eMBB data channel region is greater than the duration T_{URLLC} of the URLLC data channel region. For example, the transmission period T_{URLLC} for the URLLC subframe might be just 0.25 ms, whereas the transmission period T_{EMBB} for the eMBB subframe might be 1 ms.

The inventors have recognised one area for potential delays when transmitting data in a wireless telecommunications system is in how radio resources are allocated for a terminal device to use when it has data for uplink transmission.

FIG. 4 is a ladder diagram schematically representing signalling message exchange between a terminal device (UE) and a radio network access node (e.g. a gNB) in accordance with an established grant-based approach for allocating radio resources to a terminal device to use for uplink transmissions in a wireless telecommunications system. A grant-based uplink transmission approach is one where radio resources (e.g. in terms of time and frequency) scheduled for a terminal device's data transmissions on an uplink data channel (e.g. a physical uplink shared channel, PUSCH, in an LTE context) are dynamically allocated to the terminal device by the radio network access node to which the terminal device is connected using uplink grant control signalling.

In step S1 the terminal device determines that it has data to transmit to the network via the radio network access node. The information content of the data and reason for transmitting the data is not significant.

In step S2 the terminal device transmits signalling to the radio network access node to request a grant of uplink transmission resources for the terminal device to use for transmitting the data. This request is referred to as a scheduling request, SR, message and is transmitted using an uplink control information, UCI, message, either on an uplink control channel (e.g. a physical uplink control channel, PUCCH, in an LTE context) or piggy-backed onto a previously scheduled uplink transmission on an uplink data channel (e.g. PUSCH in an LTE context). The resources used for the scheduling request message are dedicated to the specific terminal device and so a single bit is sufficient for the terminal device to indicate its desire for a resource grant since the radio access node is aware which terminal device is requesting the grant of uplink resources.

In step S3, in response to receiving the scheduling request, SR, the radio network access node selects (i.e. schedules) radio resources on the uplink data channel (e.g. PUSCH in an LTE context) for use by the terminal device for transmitting the uplink data.

In step S4 the radio network access node transmits signalling to the terminal device to indicate the resources the radio network access node has scheduled for the terminal device to use for transmitting the uplink data. This uplink grant is communicated to the terminal device using a downlink control information, DCI, message carried on a downlink control channel (e.g. a physical downlink control channel, PDCCH, in an LTE context).

In step S5 the terminal device processes the uplink resource allocation message received in step S4 and prepares the data for uplink transmission using the resources indicted in the uplink resource allocation message.

In step S6 the terminal device transmits the uplink data on the allocated uplink radio resources on the uplink data channel (e.g. PUSCH in an LTE context).

The time between the terminal device receiving the uplink resource allocation message in step S4 and being ready to start transmitting the data in step S6 (referred to as the N2 processing delay) can be relatively long, for example corresponding to around 10 orthogonal frequency division multiplex (OFDM) symbols for a 15 KHz subcarrier spacing. This delay may be longer than desired for certain types of data, e.g. URLLC data, having relatively challenging latency targets. In view of this the inventors have recognised it can be beneficial to provide new approaches that can help reduce delays arising from this aspect of conventional approaches for allocating radio resources for terminal devices to use for communicating data in wireless telecommunications systems, for example for communicating delay intolerant data such as, but not exclusively, URLLC data.

Thus, in accordance with certain embodiments of the disclosure, an approach for transmitting data from a terminal device to a radio access node (base station) in a wireless telecommunications system involves the terminal device, in response to determining there is a block of data available for transmission, itself proposing a radio resource allocation to use for transmitting the data. The proposed (selected) radio resource allocation may, for example, be selected from within a pool of predefined radio resources. The terminal device may then in effect ask the network access node to which it is connected whether it can use the proposed radio resource allocation by transmitting a request to use the proposed radio resource allocation for transmitting the data. This request may in some respects be considered an enhanced scheduling request (because it contains additional information as compared to a conventional scheduling request such as represented in step S2 in FIG. 4). The radio access node may then decide whether or not to grant the terminal device's request to use the proposed radio resource allocation, for example having regard to the conventional principles for scheduling radio resource allocations in wireless telecommunications system (e.g. taking account of whether the proposed radio resource allocation is free or already allocated and the extent to which the terminal device transmitting the data on the proposed radio resource allocation may be expected to impact other transmissions in the wireless telecommunications system). The network access node may then transmit a response to the terminal device to indicate whether or not the request to use the proposed radio resource allocation for transmitting the data is allowed. If the request to use the proposed radio resource allocation for transmitting the data is allowed, the terminal device may then proceed to transmit the data using the proposed radio resource allocation. This can help reduce delays because the terminal device can pre-emptively start preparing to transmit the data using the proposed radio resource allocation (e.g. start forming transport blocks) before receiving the response from the network access node. Furthermore, because the response signal can be simple, e.g. a single bit indicating if the request is allowed or not allowed, it can be decoded more quickly by the terminal device than a conventional resource allocation message of the kind represented in step S4 of FIG. 4. Thus the approach can help reduce the impact of the N2 processing delay represented in FIG. 4. If the network access node determines the proposed radio resource allocation should not be used by the terminal device for transmitting the data, for example because of a scheduling clash, the response indicating the request to use the proposed resources is not allowed may also include an indication of an alternate resource allocation to use for transmitting the data. This may be provided in accordance with conventional (legacy) resource allocation techniques (for example with signalling corresponding to that represented in step S4 in FIG. 4) or in another manner such as discussed further below.

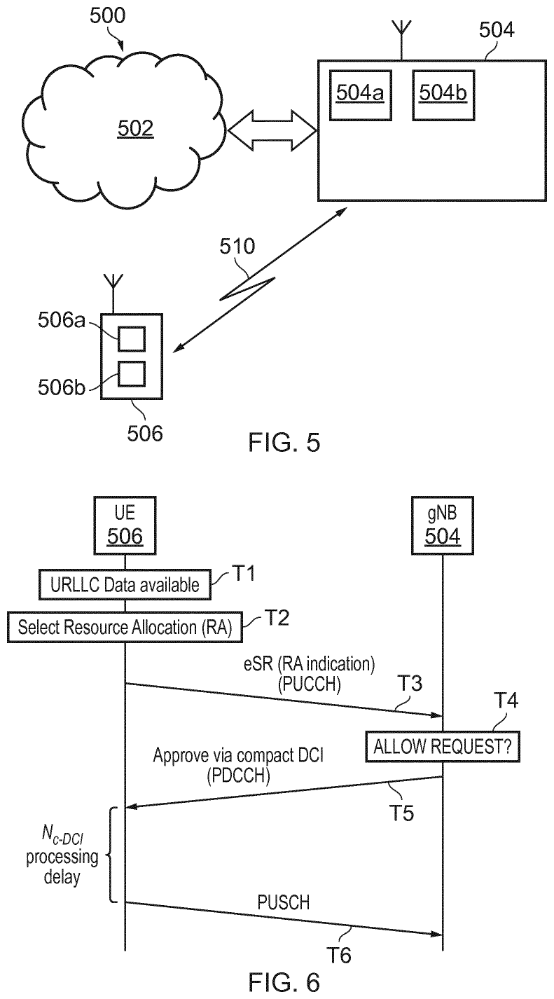

FIG. 5 schematically shows some further details of a telecommunications system 500 supporting communications between a radio access node 504 and a terminal device 506 according to certain embodiments of the present disclosure. For the sake of an example, the telecommunications system 500 here is assumed to be based broadly around an LTE-type architecture that may also support other radio access technologies, either using the same hardware as represented in FIG. 5 with appropriately configured functionality, or separate hardware configured to operate in association with the hardware represented in FIG. 5. However, the specific network architecture in which embodiments of the disclosure may be implemented is not of primary significance to the principles described herein. Many aspects of the operation of the telecommunications system/network 500 are known and understood and are not described here in detail in the interest of brevity. Operational aspects of the telecommunications system 500 which are not specifically described herein may be implemented in accordance with any known techniques, for example according to the current LTE-standards and other proposals for operating wireless telecommunications systems. The network access node 504 may, for convenience, sometimes be referred to herein as a base station 504, it being understood this term is used for simplicity and is not intended to imply any network access node should conform to any specific network architecture, but on the contrary, may correspond with any network infrastructure equipment/network access node that may be configured to provide functionality as described herein. In that sense it will appreciated the specific network architecture in which embodiments of the disclosure may be implemented is not of primary significance to the principles described herein.

The telecommunications system 500 comprises a core network part 502 coupled to a radio network part. The radio network part comprises the radio network access node 504 and the terminal device 506. It will of course be appreciated that in practice the radio network part may comprise more network access nodes serving multiple terminal devices across various communication cells. However, only one network access node and one terminal device are shown in FIG. 5 in the interests of simplicity.

The terminal device 506 is arranged to communicate data to and from the network access nodes (base stations/transceiver stations) 504 according to coverage. The network access node 504 is communicatively connected to the core network part 502 which is arranged to perform routing and management of mobile communications services for terminal devices in the telecommunications system 500 via the network access node 504. The connection from the network access nodes 504 to the core network 502 may be wired or wireless. In order to maintain mobility management and connectivity, the core network part 502 also includes a mobility management entity, MME, which manages the service connections with terminal devices operating in the communications system, such as the terminal device 506. As noted above, the operation of the various elements of the communications system 500 shown in FIG. 5 may be in accordance with known techniques apart from where modified to provide functionality in accordance with embodiments of the present disclosure as discussed herein.

The terminal device 506 is adapted to support operations in accordance with embodiments of the present disclosure when communicating with the network access node 504. In this example, it is assumed the terminal device 506 is a URLLC capable terminal device adapted for transmitting URLLC data to the network access node (base station) 504 over a radio interface 510 based on a URLLC radio frame structure, such as represented in FIG. 4, in accordance with an embodiment of the disclosure. The terminal device 506 may be referred to as a URLLC terminal device for convenience, it being understood that the device may in practice be a generic terminal device, such as a smartphone terminal device, which is running an application that relies on URLLC data. However, the URLLC device may in other cases not be a generic smartphone, but may be a device dedicated to an application that uses URLLC data, for example a machine type communications device supporting communication for an autonomous vehicle. It will be appreciated that the terminal device may support both delay intolerant data communications, e.g. for URLLC data, and delay tolerant data communications, e.g. for non-URLLC data communications. The terminal device 506 comprises transceiver circuitry 506a (which may also be referred to as a transceiver/transceiver unit) for transmission and reception of wireless signals and processor circuitry 506b (which may also be referred to as a processor/processor unit) configured to control the terminal device 506. The processor circuitry 506b may comprise various sub-units/sub-circuits for providing desired functionality as explained further herein. These sub-units may be implemented as discrete hardware elements or as appropriately configured functions of the processor circuitry. Thus the processor circuitry 506b may comprise circuitry which is suitably configured/programmed to provide the desired functionality described herein using conventional programming/configuration techniques for equipment in wireless telecommunications systems. The transceiver circuitry 506a and the processor circuitry 506b are schematically shown in FIG. 5 as separate elements for ease of representation. However, it will be appreciated that the functionality of these circuitry elements can be provided in various different ways, for example using one or more suitably programmed programmable computer(s), or one or more suitably configured application-specific integrated circuit(s)/circuitry/chip(s)/chipset(s). It will be appreciated the terminal device 506 will in general comprise various other elements associated with its operating functionality, for example a power source, user interface, and so forth, but these are not shown in FIG. 5 in the interests of simplicity.

The network access node 504 comprises transceiver circuitry 504a (which may also be referred to as a transceiver/transceiver unit) for transmission and reception of wireless signals and processor circuitry 504b (which may also be referred to as a processor/processor unit) configured to control the respective network access node 504 to operate in accordance with embodiments of the present disclosure as described herein. Thus, the processor circuitry 504b for the network access node 504 may comprise circuitry which is suitably configured/programmed to provide the desired functionality described herein using conventional programming/configuration techniques for equipment in wireless telecommunications systems. The transceiver circuitry 504a and the processor circuitry 504b are schematically shown in FIG. 5 as separate elements for ease of representation. However, it will be appreciated that the functionality of these circuitry elements can be provided in various different ways, for example using one or more suitably programmed programmable computer(s), or one or more suitably configured application-specific integrated circuit(s)/circuitry/chip(s)/chipset(s). It will be appreciated the network access node 504 will in general comprise various other elements associated with its operating functionality, such as a scheduler.

Thus, the base station 504 is configured to communicate URLLC data with the URLLC terminal device 506 according to an embodiment of the disclosure over communication link 510.

As noted above, the inventors have recognized in situations where there is a desire for data to be transmitted with more stringent latency requirements than is typical it may be beneficial for a terminal device to itself propose a selected radio resource allocation to use for transmitting the data in the form of an enhanced scheduling request that provides additional information to the network so the network can execute a different process to that shown in FIG. 4 which seeks to help reduce the delay in confirming a radio resource allocation on an uplink data channel, e.g. a physical uplink shared channel, PUSCH, in an LTE/NR context.

FIG. 6 is a ladder diagram schematically representing some operating aspects of the wireless telecommunications system 500 discussed above with reference to FIG. 5 in accordance with certain embodiments of the disclosure. In particular, the diagram represents some operations and signalling exchange associated with the terminal device 506 and network infrastructure equipment comprising the radio network access node (base station) 504 in accordance with certain embodiments of the disclosure.

The processing represented in FIG. 6 starts in step T1 in which the terminal device 506 determines that URLLC data has become available in its uplink data buffer for transmission to the radio network access node 504. The reason why the data has become available for transmission in the network and the content and ultimate destination for the data is not significant to the principles described herein. The terminal device may be a dedicated URLLC terminal device such that any data it has for uplink is deemed to be URLLC data, or the terminal device may support different services having different latency targets, and may determine the data received in the buffer is URLLC data (as opposed to data for a service with a more relaxed latency target which can be handled in a conventional way such as represented in FIG. 4), from an indication received from higher layers.

In step T2 the terminal device 506 selects a proposed allocation of radio resources (i.e. a resource allocation) to use for transmitting the data to the radio access node 504. The proposed radio resource allocation may comprise, for example, a selection of one or more of: time resources to use for transmitting the data; frequency resources to use for transmitting the data; a coding scheme to use for transmitting the data; and a transport block size to be used for transmitting the data. In principle the terminal device may have complete freedom to select the proposed radio resource allocation from within the bounds of all the radio resources available for uplink transmissions. However, in practice it may be appropriate for the terminal device to be restricted to select the proposed radio resources from within a predefined subset of all the available radio resources made available for use in approaches according to embodiments of the disclosure. In some cases there may be a partition of available radio resources from which the terminal device has freedom to select a proposed resource allocation. However, in this example it is assumed that there is a plurality of predefined potential radio resource allocations from which the terminal device can select a proposed radio resource allocation to use for transmitting the data. Each potential radio resource allocation may, for example, specify time and frequency radio resources and a modulation coding scheme and transport block size to be used for transmitting data. It will be appreciated in specifying time resources, these will most likely not be defined in an absolute sense, but in a relative sense, for example relative to a particular subframe (for example a subframe in which the terminal device sends request signalling or receives response signalling as discussed further below).

The terminal device may select the proposed radio resource allocation from the available potential proposed radio resource allocations randomly or having regard to its current status or the data to be transmitted. For example, if the data to be transmitted in accordance with embodiments of the disclosure can vary in size, the different potential resource allocations may be configured for transmitting different amounts of data, and the terminal device can select an appropriate one of the plurality of potential resource allocations having regard to the amount of data to transmit. In another example, the terminal device may have a relatively narrow-band transceiver (for example it may be a machine-type communication or other narrowband device) and the selected one of the plurality of potential resource allocations may be chosen to include frequency resources appropriate for the current status of the terminal device's transceiver (e.g.

the frequency to which it is tuned). In another example, the terminal device may have knowledge of the quality of the uplink channel, e.g. through channel reciprocity in a time division duplex (TDD) communication system or through feedback signalling from the radion access node (gNB), and the terminal device may select one of the plurality of potential resource allocations based on a resource allocation's inclusion of frequency resources that exhibit a good channel quality. In other examples the terminal device may be configured to monitor transmissions on the radio resources available on an ongoing basis, such that when it is determined there is URLCC data available for uplink transmission the terminal device can select a proposed radio resource allocation to use for transmitting the data having regard to the extent to which the different radio resources available are being used for other transmissions in the wireless telecommunications system.

In step T3 the terminal device 506 transmits request signalling to the radio network access node 504 which comprises an indication of the proposed radio resource allocation for transmitting the data. This signalling may be referred to as an enhanced scheduling request. In some respects it corresponds with the scheduling request transmitted in step S2 of the conventional approach represented in FIG. 4, but is modified to include an indication of the proposed radio resource allocation (RA indication). The request signalling may be sent broadly in accordance with conventional techniques for communicating control data in wireless telecommunications systems, for example on PUCCH in an LTE context. The specific transmission protocols used for transmitting the request signalling are not significant to the principles described herein.

In step T4, having received the enhanced scheduling request (request signalling) transmitted by the terminal device in step T3, the radio access node 504 determines whether or not to grant the terminal device's request to use the proposed radio resource allocation for transmitting the data. As noted above, the radio access node may decide whether or not to allow the request having regard to established principles for scheduling radio resource allocations in wireless telecommunications system, for example taking account of whether the proposed radio resource allocation is free or already allocated and the extent to which the terminal device transmitting the data on the proposed radio resource allocation would impact other transmissions in the wireless telecommunications system. In the example it is assumed the radio access node decides to allow the terminal device to use the requested resource allocation, for example because it not being used, or is being used by a another terminal device which the base station has decided to pre-empt (for example based on the fact the terminal device is proposing a resource allocation indicating it is important data is transmitted with low latency, even if this is detrimental to the service provided for another terminal device).

In step T5 the radio network access node 504 transmits response signalling to the terminal device 506 indicating whether or not the terminal device's request to use the proposed radio resource allocation is allowed. In some respects this response signalling corresponds with the resource allocation signalling transmitted in step S4 of the conventional approach represented in FIG. 4, but may be more compact, for example comprising a single bit for indicating whether or not the request for the proposed resource allocation has been allowed. The request signalling may be sent broadly in accordance with conventional techniques for communicating control data in wireless telecommunications systems, for example on PDCCH in an LTE context. The specific transmission protocols used for transmitting the response signalling are not significant to the principles described herein.

On receiving the response signalling in step T5, the terminal device processes the signalling to determine whether its request to use the proposed resource allocation is allowed, and in this example in which the request is allowed, proceeds in step T6 to transmit the data using the proposed resource allocation. The transmission of the data on the proposed resource allocation may be performed in accordance with conventional techniques, for example on PUSCH in an LTE context. The time taken between receiving the approval of the requests to transmit the data using the proposed radio resource allocation in step T5 and transmitting the data in step T6 is indicated in FIG. 6 as N_{c-DCI} processing delay. As discussed above, the N_{c-DCI} processing delay can be expected to be less than the N2 processing delay represented in FIG. 4 because the compact DCI message (response signalling) received in step T5 in the approach of FIG. 6 is simpler, and hence faster to decode, and the conventional DCI message (allocation signalling) received in step S4 in the approach of FIG. 4. Furthermore, although not represented in FIG. 6, in some embodiments of the disclosure the terminal device may begin processing the data for uplink transmission in accordance with the proposed resource allocation without waiting to receive an indication of whether the proposed resource allocation is granted. This can further help reduce the time needed between receiving the indication the proposed resource allocation is allowed and transmitting the data.

As noted above, the proposed resource allocation may include an indication of proposed time resources to use for transmitting the data (as well as other characteristics of the resource allocation, such as frequency resources, modulation coding scheme, transport block size). In accordance with certain embodiments of the disclosure the proposed time resources may be defined relative to the time (subframe) in which the terminal device transmits the request signalling in step T3 or the time (subframe) in which the terminal device receives the response signalling in step T5. For example, the proposed resource allocation may indicate the terminal device proposes to use particular time and frequency resources within a subframe that is N subframes after the subframe in which the response signalling is received, where N is identified in the request signalling.

Thus, certain embodiments of the disclosure propose to introduce an enhanced Scheduling Request eSR that provides additional information to the network so that the network can execute a different process to that conventionally used to allocate PUSCH resources to a terminal device in response to a scheduling request to seek to reduce the delay in providing the PUSCH resources.

As discussed above, the additional information may be a proposed radio resource allocation (Resource Allocation (RA)) which the terminal device requests to use to transmit data, e.g. URLLC data. That is to say, the terminal device in effect tells the radio network access node the resources (e.g. time & frequency) that it wishes to use for an upcoming PUSCH transmission for the data. This intended/proposed RA can also include a proposed MCS (Modulation Coding

Scheme) and proposed TBS (Transport Block Size) for the transmission of the data. In some example implementations a plurality of potential sets of time and frequency resources, MCS and TBS may be predefined and the enhanced scheduling request (eSR) may indicate a selected one of the preconfigured RAs. That is to say, selecting a proposed radio resource allocation to use for transmitting the data may comprise selecting a proposed radio resource allocation from a plurality of predetermined potential radio resource allocations. Each of the predetermined potential radio resource allocations may be considered a set of Pre-configured Uplink Resources (PUR). For example the network may configure four different potential radio resource allocations for use by the terminal device respectively associated with indices 0 to 3 and the terminal device may indicate in the eSR (request signalling) which one it proposes to use by appropriate setting of two bits to indicate the corresponding index for the selected one of the predetermined potential radio resource allocations. The potential radio resource allocations for a terminal device may be predefined/preconfigured according to one or more of: an operating standard for the wireless telecommunications system, previously received system information signalling broadcast in the wireless telecommunications system; and previously received dedicated (i.e. specific to a terminal device or group of terminal devices) radio resource control, RRC, signalling, for example.

In some example implementations, each predetermined potential radio resource allocations may contain further parameters that the terminal device may select and the network/radio access node may blind decode for them. For example, a predetermined radio resource may contain the time and frequency resources and at least two TBS. A terminal device selecting this time and frequency resource thus has further flexibility to select the TBS. The network can then blind decode the TBS for this predetermined radio resource. That is to say, some parameters of a predetermined radio resource in a plurality of predetermined radio resources may have more than one configuration for the terminal device to choose and for the radio access node to blind decode for (e.g. TBS, MCS), whilst other parameters have only one configuration (e.g. time and frequency resources).

The radio network access node may respond to an eSR with a compact form of DCI. Because the eSR contains proposed resource allocation (RA) information, a DCI message granting the requested RA does not need to contain much information. For example, in some cases the compact DCI (response signalling) might comprise a single bit with one value, e.g. 1, indicating that the radio network access node accepts the terminal device's RA request, and the other value, e.g. “0”, indicating that the radio network access node does not accepts the terminal device's RA request. If the compact DCI indicates the radio network access node accepts the terminal device's RA request, the terminal device can then proceed to transmit the data on PUSCH using its proposed radio resource allocation following reception of this compact DCI, as indicated in FIG. 6.

Having the proposed RA indicated in the eSR (request signalling in step T3 of FIG. 6) may allow for faster scheduling processing time at the radio network access node, especially for implementations in which the proposed RA is one of a set of Pre-configured Uplink Resources (PURs).

In accordance with some implementations the use of a compact DCI (response signalling is step T5 of FIG. 6), for example comprising only 1 bit, can increase reliability, for example allowing for numerous redundancy bits/repetitions without requiring a significant increase in PDCCH resources to convey the grant of the request to use the resources. However, it will be appreciated that this compact DCI may contain further information in addition to the indication of approval or otherwise of the terminal device's request. For example, it may provide the repetition of the PUSCH, power control or an alternate resource allocation. In some example implementations, the predetermined resource allocation may contain configurations sufficient for the terminal device to process part of a PUSCH, for example it may contain the TBS, MCS and the bandwidth of the frequency resource, but not the actual frequency location. The compact DCI can therefore indicate the actual frequency location. This has the benefit that the network knows (e.g. from the Sounding Reference Signal, SRS, an uplink reference signal transmitted by the terminal device) which frequency location is best in terms of radio conditions for the terminal device's transmission. This still allows the terminal device to prepare much of the PUSCH transport block, with just the final step of mapping the transport block to a granted frequency location done after receiving the compact DCI in step T5, thereby still giving an advantage in terms of processing time over the conventional method

In a situation in which the radio network access node does not approve of the requested RA in the eSR (for example because of a clash), the radio network access node may provide an indication of an alternative radio resource allocation (RA). For example, in one implementation, the radio network access node may indicate an alternative RA in the compact DCI by providing an indication, e.g. an associated index, for a different one of a plurality of predefined potential radio resource allocations to that requested by the terminal device. For example, if there are four potential RAs configured for the terminal device, e.g. via prior RRC signalling, associated with indices RA#0 to RA#3 and the terminal device indicates RA#1 in the eSR, the radio network access node may decide not to allow the terminal device to use RA#1 and instead indicate, for example in the compact DCI, that the terminal device should instead use RA#2. In this regard it should be noted in an implementation supporting a plurality of predefined potential radio resource allocations as discussed herein, in addition to starting to prepare the data for transmission using the selected/proposed radio resource allocation indicated in the scheduling request before receiving confirmation of the granted resources in the response signalling, the terminal device may also pre-emptively start to prepare the data for transmission using one or more other ones of the plurality of potential radio resource allocations before receiving confirmation of the granted resources in the response signalling. Thus, the terminal device can in some cases prepare for the eventuality that any of the potential radio resource allocations are granted by pre-processing according to all the potential radio resource allocations with a view to reducing the time needed to process the data for transfer once the radio resource allocation is confirmed.

In some examples a Group Common DCI (GC-DCI) may be used to indicate whether requests to use proposed radio resources from a plurality of terminal devices are granted. Thus a GC-DCI may be used to address/answer requests from multiple terminal devices which can help reduce DCI signalling overhead. An example implementation is with a 1 bit indication provided in the GC-DCI for each terminal device associated with the GC-DCI with the GC-DCI containing multiple fields with each field addressing a specific terminal device (e.g. a comprising a bitmap). Each terminal device associated with the GC-DCI can thus check only the field related to it to determine whether its requested RA is approved or not (the terminal device may be provided with an indication of its relevant field when in prior RRC configuration signalling. In one implementation a single bit in the GC-DCI may be used to indicate that all the terminal devices that sent an eSR have their requested RAs approved or disapproved. If this bit indicates all the requests were not approved, each terminal device may then instead be provided with a conventional/legacy resource grant. Hence if all the terminal devices requested non-clashing radio resource allocations, the radio network access node could allow all those terminal devices to use their requested radio resource allocations, but if some terminal devices requested colliding radio resource allocations, the radio network access node would indicate a set of non-colliding radio resource allocations for the terminal devices using legacy resource grants.

Thus, in some examples if the radio network access node does not approve a requested RA, the radio network access node may instead transmit a legacy/conventional resource allocation grant to the terminal device (e.g. as discussed above with reference to FIG. 4). That is to say, the radio network access node may fall-back to a legacy method in providing the PUSCH resource for the terminal device if it does not allow the terminal device access to its proposed radio resource allocation.

It will be appreciated some terminal devices may be capable of both delay sensitive (e.g. URLLC) data transmission and non-delay sensitive (e.g. eMBB) data transmission). Such terminal devices may thus transmit both an enhanced scheduling request (e.g. as discussed above with reference to Step T3 in FIG. 6) for delay sensitive data and a conventional scheduling request (e.g. as discussed above with reference to Step S2 in FIG. 4) for delay non-sensitive data. In some cases the PUCCH resource used to carry an enhanced scheduling request and a conventional scheduling request may be different to help the radio network access node differentiate between them. In some cases the radio network access node may blind decode the scheduling request format to determine whether the request is for delay tolerant (e.g. eMBB) or delay sensitive (e.g. URLLC) traffic.

In another embodiment where the terminal device is capable of both delay insensitive (e.g. eMBB) and delay sensitive (e.g. URLLC) transmissions, instead of transmitting an enhanced scheduling request for delay sensitive data and a conventional scheduling request for delay insensitive data, the terminal device may send a common format enhanced scheduling request for both delay sensitive data and delay insensitive data where the enhanced scheduling request indicates whether the uplink traffic is delay sensitive data or delay insensitive data (e.g. by setting an additional bit). Such an indication can thus inform the radio network access node about the nature of the data traffic, and hence the radio network access node can use a different process to schedule the terminal device. For example, the radio network access node may pre-empt another ongoing resource allocation to provide resources for delay sensitive data but not for delay insensitive data or indicate the terminal device should use a higher power for delay sensitive data to increase the likelihood of successful reception.

In accordance with some examples according to some embodiments of the disclosure, when the radio network access node receives an eSR for delay sensitive data it may respond with a special DCI that has a different DCI format (e.g. fewer bits) compared to a conventional DCI that provides an uplink grant for delay insensitive data (e.g. eMBB). The DCI for delay sensitive data may contain additional information such as an indication of a number of repetitions or increased power for the terminal device to use to transmit the data to increase the reliability of the uplink transmissions. The special DCI for delay sensitive data may be differentiated from a conventional DCI by being addressed to a different RNTI (e.g. a URLLC-RNTI may be defined).

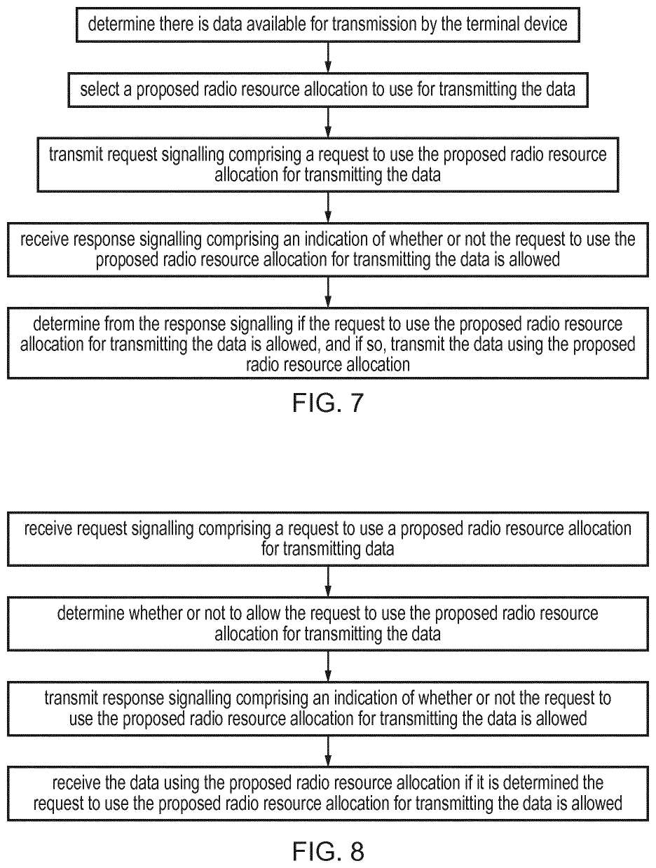

FIG. 7 is a flow diagram schematically representing a method of operating a terminal device in a wireless telecommunications system comprising the terminal device and a network access node in accordance with the principles discussed herein. In a first step of the process represented in FIG. 7, the terminal device determines there is data available for transmission by the terminal device. In a second step of the process represented in FIG. 7, the terminal device selects a radio resource allocation to use for transmitting the data. In a third step of the process represented in FIG. 7, the terminal device transmits request signalling comprising a request to use the selected radio resource allocation for transmitting the data. In a fourth step of the process represented in FIG. 7, the terminal device receives response signalling comprising an indication of whether or not the request to use the selected radio resource allocation for transmitting the data is allowed. In a fifth step of the process represented in FIG. 7, the terminal device determines from the response signalling if the request to use the selected radio resource allocation for transmitting the data is allowed, and if so, transmits the data using the selected radio resource allocation.

FIG. 8 is a flow diagram schematically representing a method of operating a radio network access node in a wireless telecommunications system comprising the radio network access node and a terminal device in accordance with the principles discussed herein. In a first step of the process represented in FIG. 8, the radio network access node receives request signalling comprising a request to use a selected radio resource allocation for transmitting data. In a second step of the process represented in FIG. 8, the radio network access node determines whether or not to allow the request to use the selected radio resource allocation for transmitting the data. In a third step of the process represented in FIG. 8, the radio network access node transmits response signalling comprising an indication of whether or not the request to use the selected radio resource allocation for transmitting the data is allowed. In a fourth step of the process represented in FIG. 8, the radio network access node receives the data using the selected radio resource allocation if it is determined the request to use the selected radio resource allocation for transmitting the data is allowed

Thus, to summarise some aspects of some approaches according to certain embodiments of the disclosure, an eSR is introduced that carries information indicating additional information for a specific type of traffic (e.g. URLLC), e.g. carrying RA information. The radio network access node may indicate whether it approves or disapproves the RA requested in the eSR. The radio network access node may respond to an eSR with a compact DCI/GC-DCI. The eSR may carry information indicating that the terminal device has delay sensitive data to transmit.

Thus there has been described a method of transmitting data by a terminal device in a wireless telecommunications system, wherein the method comprises the terminal device: determining there is data available for transmission by the terminal device; selecting a proposed radio resource allocation to use for transmitting the data; transmitting request signalling comprising a request to use the proposed radio resource allocation for transmitting the data; receiving response signalling comprising an indication of whether or not the request to use the proposed radio resource allocation for transmitting the data is allowed; and transmitting the data using the proposed radio resource allocation if the response signalling indicates the request to use the proposed radio resource allocation for transmitting the data is allowed.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known/derivable by both the base station and the terminal device. It will be appreciated such predetermined/predefined information may in general be established, for example, by definition in an operating standard for the wireless telecommunication system, or in previously exchanged signalling between the base station and terminal devices, for example in system information signalling, or in association with radio resource control setup signalling. That is to say, the specific manner in which the relevant predefined information is established and shared between the various elements of the wireless telecommunications system is not of primary significance to the principles of operation described herein.

It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:

Paragraph 1. A method of transmitting data by a terminal device in a wireless telecommunications system, wherein the method comprises the terminal device: determining there is data available for transmission by the terminal device; selecting a proposed radio resource allocation to use for transmitting the data; transmitting request signalling comprising a request to use the proposed radio resource allocation for transmitting the data; receiving response signalling comprising an indication of whether or not the request to use the proposed radio resource allocation for transmitting the data is allowed; determining from the response signalling if the request to use the proposed radio resource allocation for transmitting the data is allowed, and if so, transmitting the data using the proposed radio resource allocation.

Paragraph 2. The method of paragraph 1, further comprising the terminal device starting to prepare the data for transmission using the proposed radio resource allocation prior to receiving the response signalling.

Paragraph 3. The method of paragraph 1 or 2, wherein the proposed radio resource allocation comprises one or more of: an indication of time resources to use for transmitting the data; an indication of frequency resources to use for transmitting the data; an indication of a coding scheme to use for transmitting the data; and an indication of a transport block size to be used for transmitting the data.

Paragraph 4. The method of any of paragraphs 1 to 3, wherein selecting a proposed radio resource allocation to use for transmitting the data comprises selecting the proposed radio resource allocation from a plurality of predetermined potential radio resource allocations.

Paragraph 5. The method of paragraph 4, wherein each of the plurality of predetermined potential radio resource allocations is associated with an index and the request signalling comprises an indication of an index associated with the proposed radio resource allocation.

Paragraph 6. The method of paragraph 4 or 5, wherein the plurality of predetermined radio resource allocations are predefined according to one or more of: an operating standard for the wireless telecommunications system, previously received system information signalling broadcast in the wireless telecommunications system; and previously received terminal device specific radio resource control, RRC, signalling.

Paragraph 7. The method of any of paragraph 4 to 6, further comprising the terminal device starting to prepare the data for transmission using a plurality of the predetermined potential radio resource allocations prior to receiving the response signalling.

Paragraph 8. The method of any of paragraph 1 to 7, further comprising establishing from the response signalling an alternative radio resource allocation to use for transmitting the data if the response signalling indicates the request to use the proposed radio resource allocation for transmitting the data is not allowed.

Paragraph 9. The method of any of paragraph 1 to 8, wherein the response signalling comprises a plurality of indications respectively indicating whether or not requests to use proposed radio resource allocations from respective ones of a corresponding plurality of terminal devices are allowed.

Paragraph 10. The method of any of paragraphs 1 to 9, further comprising determining the data is delay sensitive data before transmitting request signalling comprising a request to use the proposed radio resource allocation for transmitting the data.

Paragraph 11. The method of paragraph 10, wherein the request signalling comprises an indication the data is delay sensitive data.

Paragraph 12. The method of any of paragraphs 1 to 11, further comprising: determining there is further data available for transmission by the terminal device; classifying the further data as not delay sensitive data; transmitting further request signalling comprising an indication of a request for a grant of a radio resource allocation to use for transmitting the further data; receiving further response signalling comprising an indication a granted radio resource allocation; and transmitting the further data using the granted radio resource allocation.

Paragraph 13. The method of paragraph 12, wherein the response signalling comprising the indication of whether or not the request to use the proposed radio resource allocation for transmitting the data is allowed comprises fewer information bits than the further response signalling comprising the indication of a granted radio resource allocation.

Paragraph 14. A terminal device for transmitting data in a wireless telecommunications system, wherein the terminal device comprises controller circuitry and transceiver circuitry configured to operate together such that the terminal device is operable to: determine there is data available for transmission by the terminal device; select a radio resource allocation to use for transmitting the data; transmit request signalling comprising a request to use the proposed radio resource allocation for transmitting the data; receive response signalling comprising an indication of whether or not the request to use the proposed radio resource allocation for transmitting the data is allowed; determine from the response signalling if the request to use the proposed radio resource allocation for transmitting the data is allowed, and if so, transmit the data using the proposed radio resource allocation.

Paragraph 15. Circuitry for a terminal device for transmitting data in a wireless telecommunications system, wherein the circuitry comprises controller circuitry and transceiver circuitry configured to operate together such that the circuitry is operable to: determine there is data available for transmission by the terminal device; select a radio resource allocation to use for transmitting the data; transmit request signalling comprising a request to use the proposed radio resource allocation for transmitting the data; receive response signalling comprising an indication of whether or not the request to use the proposed radio resource allocation for transmitting the data is allowed; determine from the response signalling if the request to use the proposed radio resource allocation for transmitting the data is allowed, and if so, transmit the data using the proposed radio resource allocation.

Paragraph 16. A method of receiving data by a radio network access node in a wireless telecommunications system, wherein the method comprises the radio network access node: receiving request signalling comprising a request to use a proposed radio resource allocation for transmitting data; determining whether or not to allow the request to use the proposed radio resource allocation for transmitting the data; transmitting response signalling comprising an indication of whether or not the request to use the proposed radio resource allocation for transmitting the data is allowed; and receiving the data using the proposed radio resource allocation if it is determined the request to use the proposed radio resource allocation for transmitting the data is allowed.

Paragraph 17. A radio network access node for receiving data in a wireless telecommunications system, wherein the radio network access node comprises controller circuitry and transceiver circuitry configured to operate together such that the radio network access node is operable to: receive request signalling comprising a request to use a proposed radio resource allocation for transmitting data; determine whether or not to allow the request to use the proposed radio resource allocation for transmitting the data; transmit response signalling comprising an indication of whether or not the request to use the proposed radio resource allocation for transmitting the data is allowed; and receive the data using the proposed radio resource allocation if it is determined the request to use the proposed radio resource allocation for transmitting the data is allowed.

Paragraph 18. Circuitry for a radio network access node for receiving data in a wireless telecommunications system, wherein the circuitry comprises controller circuitry and transceiver circuitry configured to operate together such that the radio network access node is operable to: receive request signalling comprising a request to use a proposed radio resource allocation for transmitting data; determine whether or not to allow the request to use the proposed radio resource allocation for transmitting the data; transmit response signalling comprising an indication of whether or not the request to use the proposed radio resource allocation for transmitting the data is allowed; and receive the data using the proposed radio resource allocation if it is determined the request to use the proposed radio resource allocation for transmitting the data is allowed.

### REFERENCES

[1] 3GPP document RP-160671, “New SID Proposal: Study on New Radio Access Technology,” NTT DOCOMO, RAN#71, Gothenburg, Sweden, 7 to 10 Mar. 2016

[2] 3GPP document RP-172834, “Work Item on New Radio (NR) Access Technology,” NTT DOCOMO, RAN#78, Lisbon, Portugal, 18 to 21 Dec. 2017

[3] 3GPP document RP-182089, “New SID on Physical Layer Enhancements for NR Ultra-Reliable and Low Latency Communication (URLLC),” Huawei, HiSilicon, Nokia, Nokia Shanghai Bell, RAN#81, Gold Coast, Australia, 10 to 13 Sep. 2018

[4] Holma H. and Toskala A, “LTE for UMTS OFDMA and SC-FDMA based radio access”, John Wiley and Sons, 2009

1. A method of transmitting data by a terminal device in a wireless telecommunications system, wherein the method comprises the terminal device:
determining there is data available for transmission by the terminal device;
selecting a proposed radio resource allocation to use for transmitting the data;
transmitting request signalling comprising a request to use the proposed radio resource allocation for transmitting the data;
receiving response signalling comprising an indication of whether or not the request to use the proposed radio resource allocation for transmitting the data is allowed;
determining from the response signalling if the request to use the proposed radio resource allocation for transmitting the data is allowed, and if so, transmitting the data using the proposed radio resource allocation.

2. The method of claim 1, further comprising the terminal device starting to prepare the data for transmission using the proposed radio resource allocation prior to receiving the response signalling.

3. The method of claim 1, wherein the proposed radio resource allocation comprises one or more of: an indication of time resources to use for transmitting the data; an indication of frequency resources to use for transmitting the data; an indication of a coding scheme to use for transmitting the data; and an indication of a transport block size to be used for transmitting the data.

4. The method of claim 1, wherein selecting a proposed radio resource allocation to use for transmitting the data comprises selecting the proposed radio resource allocation from a plurality of predetermined potential radio resource allocations.

5. The method of claim 4, wherein each of the plurality of predetermined potential radio resource allocations is associated with an index and the request signalling comprises an indication of an index associated with the proposed radio resource allocation.

6. The method of claim 4, wherein the plurality of predetermined radio resource allocations are predefined according to one or more of: an operating standard for the wireless telecommunications system, previously received system information signalling broadcast in the wireless telecommunications system; and previously received terminal device specific radio resource control, RRC, signalling.

7. The method of claim 4, further comprising the terminal device starting to prepare the data for transmission using a plurality of the predetermined potential radio resource allocations prior to receiving the response signalling.

8. The method of claim 1, further comprising establishing from the response signalling an alternative radio resource allocation to use for transmitting the data if the response signalling indicates the request to use the proposed radio resource allocation for transmitting the data is not allowed.

9. The method of claim 1, wherein the response signalling comprises a plurality of indications respectively indicating whether or not requests to use proposed radio resource allocations from respective ones of a corresponding plurality of terminal devices are allowed.

10. The method of claim 1, further comprising determining the data is delay sensitive data before transmitting request signalling comprising a request to use the proposed radio resource allocation for transmitting the data.

11. The method of claim 10, wherein the request signalling comprises an indication the data is delay sensitive data.

12. The method of claim 1, further comprising:
determining there is further data available for transmission by the terminal device;
classifying the further data as not delay sensitive data;
transmitting further request signalling comprising an indication of a request for a grant of a radio resource allocation to use for transmitting the further data;
receiving further response signalling comprising an indication a granted radio resource allocation; and
transmitting the further data using the granted radio resource allocation.

13. The method of claim 1, wherein the response signalling comprising the indication of whether or not the request to use the proposed radio resource allocation for transmitting the data is allowed comprises fewer information bits than the further response signalling comprising the indication of a granted radio resource allocation.

14. A terminal device for transmitting data in a wireless telecommunications system, wherein the terminal device comprises controller circuitry and transceiver circuitry configured to operate together such that the terminal device is operable to:
determine there is data available for transmission by the terminal device;
select a radio resource allocation to use for transmitting the data;
transmit request signalling comprising a request to use the proposed radio resource allocation for transmitting the data;
receive response signalling comprising an indication of whether or not the request to use the proposed radio resource allocation for transmitting the data is allowed;
determine from the response signalling if the request to use the proposed radio resource allocation for transmitting the data is allowed, and if so, transmit the data using the proposed radio resource allocation.

15. Circuitry for a terminal device for transmitting data in a wireless telecommunications system, wherein the circuitry comprises controller circuitry and transceiver circuitry configured to operate together such that the circuitry is operable to:
determine there is data available for transmission by the terminal device;
select a radio resource allocation to use for transmitting the data;
transmit request signalling comprising a request to use the proposed radio resource allocation for transmitting the data;
receive response signalling comprising an indication of whether or not the request to use the proposed radio resource allocation for transmitting the data is allowed;
determine from the response signalling if the request to use the proposed radio resource allocation for transmitting the data is allowed, and if so, transmit the data using the proposed radio resource allocation.

16.-18. (canceled)
